(19) United States
(12) Patent Application Publication
(10) Pub. No.: US 2024/0318543 A1
(43) Pub. Date: Sep. 26, 2024

(54) BOREHOLE FLUID FLOW MODELLING USING DYNAMIC PRESSURE BOUNDARY

(71) Applicant: Halliburton Energy Services, Inc., Houston, TX (US)

(72) Inventors: Zhonghuan CHEN, Singapore (SG); Wei ZHANG, Katy, TX (US); Xiaoguang Allan ZHONG, Singapore (SG); Christopher Michael JONES, Houston, TX (US)

(73) Assignee: Halliburton Energy Services, Inc., Houston, TX (US)

(21) Appl. No.: 18/125,499

(22) Filed: Mar. 23, 2023

(51) Int. Cl. E21B 47/06; E21B 47/08

(52) U.S. Cl. CPC E21B 47/06; E21B 47/08; E21B 47/10; G06F 30/28; E21B 2200/20

(57) ABSTRACT

Systems and techniques are described for modeling borehole fluid flow using a dynamic pressure boundary. An example method can include calculating a radius of fluids and a radius of pressure associated with a borehole, the radius of pressure relating to a fluid flow; generating a first model, wherein a size of the first model is larger than the calculated radius of pressure; determining a dynamic pressure based on the first model; generating a second model, wherein a size of the second model is larger than the calculated radius of fluids; and modelling the borehole fluid flow based on the second model, wherein the dynamic pressure is used as a boundary condition of the second model.

### TECHNICAL FIELD

The present technology pertains to oil and gas production and, more specifically, modeling borehole fluid flows using a dynamic pressure boundary.

### BACKGROUND

Borehole fluid flow modelling can be a reliable tool to help understand subsurface fluid distributions in a reservoir. In some cases, borehole fluid flow modelling can predict or can be used to predict pressure dynamics during formation fluid sampling as well as fluid injection operations in the wellbore. Therefore, borehole fluid flow modelling can be used to predict the dynamic state of the reservoir during fluid injection, which can help guide job planning and other concerns and activities during an injection operation.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an example wireline environment, in accordance with various aspects of the subject technology;

FIG. 2 illustrates an example process for multi-scale borehole fluid flow modelling, in accordance with various aspects of the subject technology;

FIG. 3 illustrates example sizes of a rough model for calculating a dynamic pressure boundary and a detailed model for modeling a borehole fluid flow, in accordance with various aspects of the subject technology;

FIG. 4 shows a graph illustrating an example of dynamic pressures observed in a rough model used for modeling a borehole fluid flow such as the rough model in FIG. 3, in accordance with various aspects of the subject technology;

FIG. 5 illustrates a graph that presents an example borehole pressure that can support an example constant injection rate, in accordance with various aspects of the subject technology;

FIG. 6 is a flowchart illustrating an example process for modelling borehole fluid flows, in accordance with various aspects of the subject technology;

FIG. 7 illustrates an example computing device architecture which can be employed to perform various steps, methods, and techniques disclosed herein.

### DETAILED DESCRIPTION

Various examples and aspects of the disclosure are discussed in detail below. While specific examples and aspects are discussed, it should be understood that this is done for illustration purposes only. A person skilled in the relevant art will recognize that other examples, aspects, components, and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

As discussed above, borehole fluid flow modelling can be a reliable tool to help operators and field engineers understand subsurface fluid distributions in a reservoir. For example, borehole fluid flow modelling can be used to predict pressure dynamics during formation fluid sampling and/or fluid injection operations in a wellbore. In formation sampling or testing, it can be useful for field engineers to understand the dynamic change of fluid distribution in the reservoir during the operation. In some cases, this information can help them make optimal decisions relating to sampling job planning (such as, for example, selection of probes, and the sampling time to reach the acceptable contamination level). Borehole fluid flow modelling can predict this information in detail before the job operation. Moreover, during fluid injection, borehole fluid flow modelling can be useful for field safety by helping field engineers understand the dynamic fluid distribution during the injection as well as the dynamic pressure changes.

However, in some cases, limitations on available computational resources can limit the size of the fluid flow model, thereby limiting a well operator's ability to fully or better understand subsurface fluid distribution in a reservoir. For example, in some cases, the size of meshing in part of the reservoir model may need to be smaller than the detailed features in the model (such as, for example, the probe or wellbore which can have fine geometric information). Conversely, in some cases, the size of the model may need to be large enough to account for the pressure propagation in the reservoir. In some cases (e.g., such as situations where the fluids have a compressibility below a threshold and a mobility above a threshold), the pressure can propagate considerably thereby largely increasing the size of the model and the number of meshes used, which can lead to the meshing quality being too low to achieve a desired and/or threshold accuracy and/or to be used for, and/or provide certain uses and/or benefits for, fluid flow modelling.

Described herein are systems, apparatuses, processes (also referred to as methods), and computer-readable media (collectively referred to as “systems and techniques”) for modeling borehole fluid flows using a dynamic pressure boundary. The systems and techniques described herein can address and overcome the foregoing problems associated with the limitations of computation resources in relation to borehole fluid flow modelling. As explained in more detail below, by employing a dynamic pressure boundary condition instead of fixed far-field pressure boundary condition during borehole fluid flow modelling, the size of the wellbore modelled by an example borehole fluid flow model of the systems and techniques described herein can be smaller than the region of the pressure propagation in that wellbore, while also maintaining a high-resolution mesh to handle the detailed features of the probe and wellbore. In some examples, the systems and techniques described herein can avoid boundary effects by applying a dynamic pressure condition instead of a fixed far-field pressure condition on an outer surface boundary of a detailed model. The dynamic pressure boundary can be calculated from a rough model as described in more detail below. In some examples, the size of the wellbore region being modelled can be larger than the pressure propagation. Moreover, in some cases, a coarse mesh can ignore the detailed features of the wellbore and probe. In some examples, the systems and techniques described herein can implement a multi-scale modelling process. The multi-scale modelling process can determine the size of a rough pressure model and the size of a corresponding detailed fluid flow model.

In some aspects, the borehole fluid flow modelling performed based on the systems and techniques described herein can address the challenges faced with employing large models (e.g., models that are larger than a threshold size and/or that have a number of values, parameters, and/or data objects that exceeds a threshold) by avoiding a boundary effect and/or providing a high resolution (e.g., at least a threshold resolution) and detailed model. In some cases, a rough model can determine the pressure field based on a large model (e.g., a larger model and/or a model having a same and/or number of values, parameters, and/or objects that exceeds a threshold). The detailed model can subsequently handle the detailed features (e.g., features related to the probe and wellbore) with more accuracy. In some examples, a detailed model can be a small model (e.g., a model within the acceptable limits of the computing resources) with a dynamic pressure boundary. The rough model can ignore the detailed features of probes and wellbores in order to reduce computational resources and time, among other factors. In some examples, the rough model can obtain the general pressure fields on a large model (e.g., the rough model must be larger than the radius of pressure propagation.) thereby allowing the detailed model to avoid boundary effects. This approach can yield accurate predictions in a shorter time than other approaches using limited computing resources (e.g., less computing resources than other approaches and/or less computing resources than needed to generate the accurate predictions).

In some cases, during formation testing and transient pressure analysis, formation permeability and fluid viscosity can be estimated by comparing a measured borehole pressure with predicted pressures obtained via borehole fluid flow modelling. The borehole fluid flow modelling performed using the systems and techniques described herein can be used in high permeable media where previous methods of borehole fluid flow modelling yield inaccurate results due to the limited size of the numerical model used by the previous methods to model borehole fluids. In some cases, the borehole fluid flow modelling performed using the systems and techniques described herein can predict the dynamic state in the reservoir during fluid injection and guide the job planning for the injection operation. In some examples, the borehole fluid flow modelling performed using the systems and techniques described herein can provide accurate predictions while reducing the computational time needed and/or utilized by employing a smaller model (e.g., a smaller model than a model used by other approaches to model borehole fluid flows and/or a model having a smaller data size, a smaller amount of variables/parameters, and/or a smaller amount of data objects) in cases with low compressible fluids (e.g., brine injection).

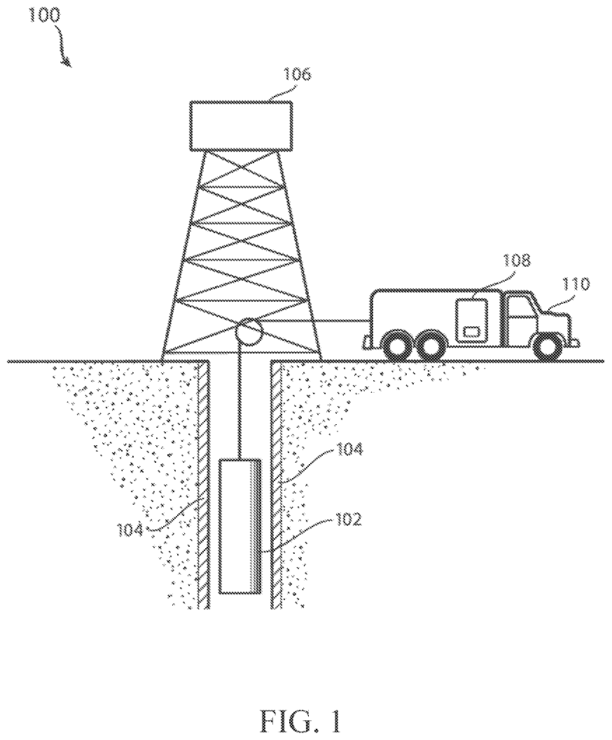

Examples of the systems and techniques described herein for modeling borehole fluid flows using a dynamic pressure boundary are illustrated in FIG. 1 through FIG. 7 and described below.

FIG. 1 is a diagram illustrating an example wireline logging system 100, according to some examples of the present disclosure. In this example wireline logging system 100, a wireline probe 102 is probing a well/borehole having a casing 104. The wireline probe 102 is connected by a wireline cable to a well-logging truck 110 located at the rig site 106. The wireline cable provides power to the wireline probe 102 and is used to transmit measurements taken from the wireline probe 102 to the well-logging truck 110. The well logging truck 110 contains a computer 108 that receives the measurements, preferably stores the measurements, and utilizes the measurements for analyses of the well, the formation surrounding the well, flow rates, etc. In some examples, the computer 108 that receives the measurements, stores the measurements, and utilizes the measurements for analyses of the well can perform the borehole fluid flow modelling used to help operators and field engineers understand subsurface fluid distribution in a reservoir as described herein.

In some cases, computer-based borehole fluid flow modelling methods can be designed to use numerical model of a limited size due to limited computing resources, and limited time, among other limitations. Examples can include but are not limited to the finite elements method, the finite difference method, and the finite volume method. In some examples, two types of errors associated with approximating the physical fluid flow using numerical fluid flow modelling methods include the “boundary effect” and the “meshing error.” The boundary effect can result from using a numerical model of limited size to model fluid flow and pressure propagations in a real-world reservoir where the physical field can be nearly infinite. Therefore, in some scenarios, a larger model size that is not always practical can be desired to accurately model the fluid flow and pressure propagations. That is, the larger the numerical model size, the closer the pressure on the outer surface of the model can be to the far field pressure, thereby lessening the effect of the boundary effect on the model. Meshing error can occur because fluids flow can be continuous in a physical space, while in numerical modelling the physical space can be expressed by discrete meshes. The size of meshes can therefore control the spatial resolution of the model. The smaller the meshing size is, the higher the spatial resolution can become, and subsequently the more detailed the fluid flow and pressure propagation modelling can be expressed in the numerical model.

In some examples, both increasing the model size and decreasing the meshing size can produce more meshes and result in exceedingly large memory usage and longer computational time. In some cases of borehole fluid flow modelling, the meshing size can be limited by the size of the probe and the wellbore because the injection and sampling are implemented by employing a probe against the wall of a wellbore. On the other hand, the model size can depend on the pressure propagation in the fluid system, which is related to the fluid properties, such as the permeability, viscosity and the compressibility. In the cases with high permeable and less compressible fluids, the radius of pressure can be many times larger than the size of wellbore and can therefore lead to millions of meshing elements in some cases. In some examples, as the number of meshing elements increases, the memory and computational time cost can also increase dramatically.

In some examples, the number of meshes can be reduced by using an adaptive meshing size on a different part of the model. Since the time step size can depend on the smallest meshing size based on a stability condition, it can yield a high dispersive error for elements of larger meshing size. The meshing quality can reduce due to the divergence among the meshes. In practical borehole fluid flow modelling, the meshing size on the outer surface of the model can be as large as thousands of times as the meshing size on the probe. However, in some cases (e.g., such as injection of low compressible water into shale rocks with low porosity), the numerical modelling problem can still be too large.

In some examples, there can be a tradeoff between accounting for the boundary effect and the meshing error in borehole fluid flow modelling. For example, a small model can be used in the formation sampling modelling, since it can take into account the mud filtrate contamination in the sampling probe. The contamination can be sensitive to the detailed features of the probe near the wellbore instead of the dynamic pressure field, and therefore the boundary effect of a small model can be ignored in some cases. In other applications, the modelling can be sensitive to the model size. For example, formation testing can provide information about the dynamic pressure buildup and a small model can limit the modelling for the infinite acting radial flow (IARF), and result in an inaccurate transient pressure analysis. In some fluid injection modelling scenarios, the limited model size can produce incorrect results such as, for example, a fake fluid barrier. Aspects of the disclosed technology provide solutions to these problems by providing a method of borehole fluid flow modelling method that reduces the boundary effect on small numerical models.

Consider an oil reservoir with a rock matrix of porosity φ, filled by a fluid with viscosity μ and compressibility c. The fluids keep static at the initial stage, with velocity u(0)=0 and the initial pressure P₀. With fluid injection or sampling operations, the fluids in the porous media can follow Equation (1) below, which is a mass conservation equation:

$$\frac{\partial ϕρ}{\partial t} + {∇}^{T} ( ρ u ) = 0 , \qquad Equation ( 1 )$$

where ρ is the dynamic density. At an arbitrary point in the reservoir, the fluids flow against the gradient of the pressure can follow Equation (2) below (e.g., the Darcy's equation):

$$u = - \frac{K}{μ} ∇ P , \qquad Equation ( 2 )$$

where K is the permeability tensor of the rock matrix.

In some examples, the fluids can be injected into (or sampled from) the reservoir through an active surface S instead of a whole wall of the wellbore. This active surface S can include, for example, a segment of wellbore surface sealed by a dual-packer in a drill stem test (DST) tool, or a contact surface of a probe in a wireline tool, among other surfaces. The injection (or sampling) rate q(t) can be controlled by one or more users (e.g., the engineering team), with consideration for time and cost in operation as well as safety related to the subsurface pressure. The flowrate q(t) can be defined by a flow direction from the wellbore into the reservoir. Moreover, q(t)<0 can denote the formation sampling operation. As used herein, the term injection can denote injection and sampling wellbore operations.

In some examples, the reservoir can be larger than the radius of the wellbore. In some cases, the pressure at locations located beyond a threshold distance from the wellbore may not be affected by the operations in the wellbore. In these scenarios, the far field pressure can be assumed to be constant during the operations. In some examples, the fluid dynamics near the borehole (e.g., within a proximity to the borehole) can be determined by solving the above Navier-Stokes-Darcy system with the following boundary conditions:

$$\{ \begin{matrix}u ( x , t ) = \frac{q ( t )}{A} n , & x ∈ S \\ P ( ∞ , t ) = {P}_{0} & \end{matrix} , \qquad Equation ( 3 )$$

where A is the area of the active injection or sampling surface S, and n is the normal direction of the active surface towards the inner side.

In some cases, Equations (1)-(3) above can be termed the boundary value problem (“BVP”) and defined as an infinite model. In some cases, numeric methods (including, but not limited to, finite differences or finite elements methods) can be defined as a fluid flow model of a finite size. Using the far-field pressure as the boundary condition at the outer surface of the finite model, the numerical modelling can be different from the physical fluid flow (e.g., the boundary effect). In some examples, the boundary effect can depend on the size of the entire borehole fluid flow model. For example, the larger the size of the numerical model, the less boundary effect exists. However, due to limitations of computational resources and other factors, the model size may not be large enough for all cases. In order to reduce the boundary effect, a multi-scale borehole fluid flow modelling method can be implemented, as further described herein.

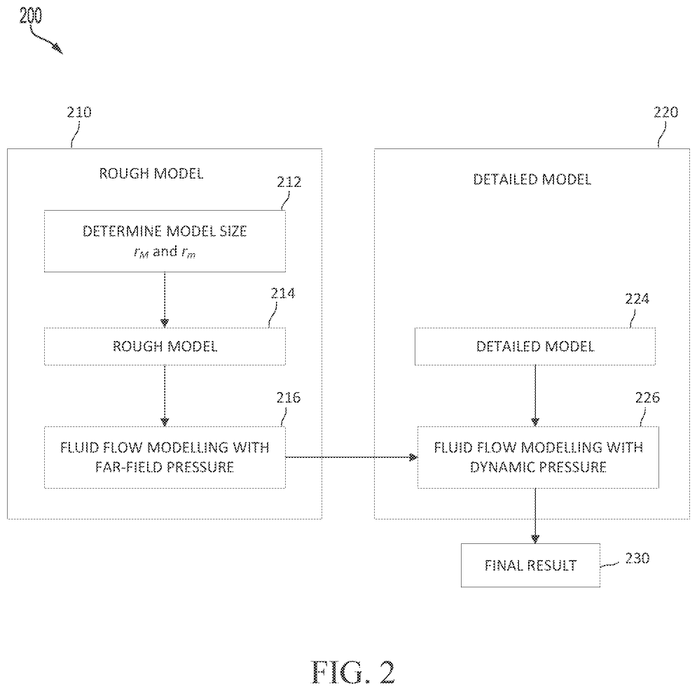

FIG. 2 illustrates an example process 200 for multi-scale borehole fluid flow modelling. In some examples, the boundary effect depends on the size of the borehole fluid flow model used to model borehole fluid flows. For example, in some scenarios, the larger the numerical model is, the less boundary effect exists. However, in some scenarios, due to the limitation of computational resources (and other factors), it can be difficult to make the model size large enough for all cases. Therefore, in some examples, the boundary effect can be reduced by employing the process 200 for multi-scale borehole fluid flow modelling illustrated in FIG. 2.

As shown in FIG. 2, the process 200 for multi-scale borehole fluid flow modelling can include a large scale rough model 210 and a small scale detailed model 220 that together form and/or are part of a multi-scale borehole fluid flow model. The rough model 210 has a larger model size r_{M} than the detailed model 220 and/or can have a size r_{M} that is larger than a threshold (e.g., the size can relate to a data size, a number of variables/parameters, and/or a number of data objects) to reduce or avoid the boundary effect. The detailed model 220 uses a dynamic pressure profile on the boundary of a smaller model with rₘ<<r_{M}. As discussed above, the rough model 210 ignores the detailed features of a probe to reduce the memory usage and computational time, while the detailed model 220 uses fine meshing to model the detailed features and control the meshing error. The process 200 described can reduce both the boundary effect and the meshing error to produce a final result 230.

At block 212, the process 200 can include determining the model sizes rₘ and r_{M} of the rough model 210 and the detailed model 220. In some examples, the model sizes can be determined by defining one or more variables related to the physical fluid flow, such as the radius of fluids (r_{f}) and the radius of pressure (rₚ). The radius of fluids (r_{f}) can be defined as the distance the fluid can reach after injection or sampling during time t, with a flowrate q(t). The total volume of fluids injected into the reservoir can be calculated through the integral as follows:

$$V = {{\int }^{t}}_{0} \vert q ( τ ) \vert d τ . \qquad Equation ( 4 )$$

In operation, these fluids can be injected into the holes between the solid particles in the porous rocks. Assuming that the reservoir rock has a porosity φ, the radius of fluids (r_{f}) can be described as follows:

$${r}_{f} = \sqrt[3]{\frac{3 V}{4 φπ}} . \qquad Equation ( 5 )$$

The radius of pressure (rₚ) can be defined as the distance that the pressure can propagate in the fluids. The distance of pressure propagation can depend on the mobility and compressibility of the fluids. For example, a higher mobility and a lower compressibility of the fluids can permit the pressure to propagate farther than a lower mobility or higher compressibility of the fluids. In some examples, the radius of pressure (rₚ) can be estimated as follows:

$${r}_{p} = 2 \sqrt{\frac{kt}{μφ c}} , \qquad Equation ( 6 )$$

wherein k can be the permeability on the fast direction, and μ and c are the viscosity and compressibility of the fluids, respectively.

In some examples, during injection or sampling for a specific time, the operation may only affect the fluid state in the reservoir at a distance (e.g., several feet away) from the wellbore. For example, the radius of pressure (rₚ) can be a small distance (e.g., tens of feet) away and/or less than a threshold distance way during injection of highly compressible CO₂ into a shale reservoir. Alternatively, the radius of pressure (rₚ) can be a larger distance (e.g., thousands of feet) away and/or more than a threshold distance away during injection of brine water into high permeable sand rocks. Generally speaking, the radius of fluids (r_{f}) is related to the fluid flow velocity, while the radius of pressure (rₚ) is related to the acoustic velocity. In some examples, the acoustic velocity can be much faster than the fluid flow velocity, and therefore r_{f}<<rₚ in general cases.

In some examples, the rough model 214 can use a fixed far-field pressure on the outer surface of the rough model 214. In these examples, the numerical model of the rough model 214 can be large enough so that the fluids do not reach the outer boundary of the model during the fluid flow process and/or the pressure does not propagate to the outer boundary of the model. In order to obtain the accurate pressure field, the rough model 214 can be designed with the size r_{M}>rₚ to avoid the boundary effect. On the other hand, the detailed model 224 can use the dynamic pressure as the boundary condition, wherein no boundary effect will exist if the injected fluids cannot reach the boundary. Otherwise, in some examples, another boundary condition defined by the ratio between the injected fluids and the formation fluids can be specified. In the examples herein, the detailed model 224 uses a model size rₘ that is larger than the radius of fluids r_{f}. As r_{f}<<rₚ in general cases, the detailed model can therefore be smaller than the rough model, and a finer meshing can be used to model the detailed features.

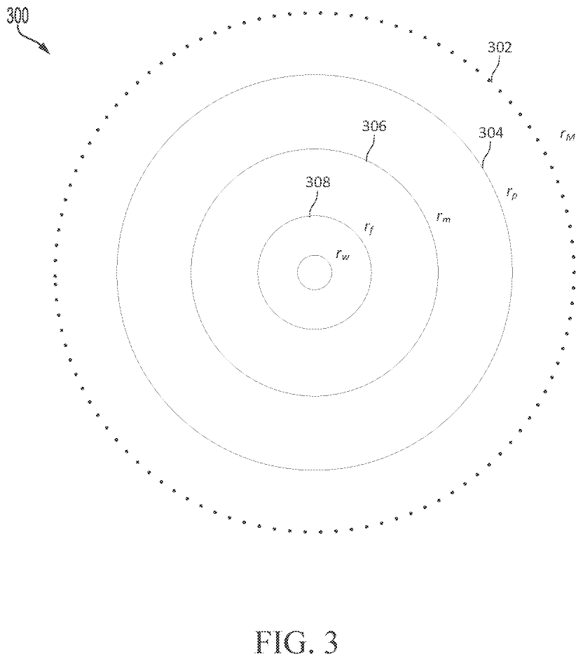

FIG. 3 is a diagram illustrating example sizes 300 of the rough model 214 and the detailed model 224 shown in FIG. 2. As shown in FIG. 3, in some examples, the rough model size (r_{M}) 302 can be larger than the radius of pressure (rₚ) 304, while the detailed model size (rₘ) 306 can be smaller than the radius of pressure (rₚ) 304. Moreover, as shown in FIG. 3, the rough model size (r_{M}) 302 can be larger than the radius of pressure (rₚ), while the detailed model size (rₘ) 306 can be larger than the radius of fluids (r_{f}) 308.

Returning to FIG. 2, the rough model 214 will be explained in more detail. In some examples, the objective of the rough model 214 can include to obtain the general pressure field in the fluid flow. As described above, the pressure field can be sensitive to the boundary effect. In rough modelling, the outer surface of the model can be applied with the following fixed far-field pressure as the boundary condition:

$$P ( {r}_{M} , t ) = {P}_{0} . \qquad Equation ( 7 )$$

In some examples, the rough model can be as large as thousands of feet in order to avoid the boundary effect.

On the other hand, in some examples, the fluid injection or sampling can act as a pressure source at the probe. For example, the probe can be small compared to the large model size. Therefore, in order to reduce the memory and computational time, the details (e.g., size and shape) of the probe can be ignored and the probe can be considered a point source in the rough modelling stage. Moreover, as the radius of fluids (r_{f}) can be smaller than the radius of pressure (rₚ), the rough model 214 can be at least partly filled with the reservoir fluids. In some examples, for simplification, the rough model 214 may only consider the formation fluids. However, in other examples, the rough model 214 may consider other elements and/or fluids in addition to or in lieu of the formation fluids.

In some examples, the rough model 214 can be implemented in three-dimensional (3D) modelling with meshes of a threshold size or above a threshold size, two-dimensional (2D) modelling with n number of components (4 components, for example), 2D scalar pressure modelling, and/or one-dimensional (1D) isotropic pressure modelling, among other models. Regarding 3D modelling with meshes of a threshold size or above a threshold size, in rough modelling for general pressure field, fluid injection and sampling can be simplified through a larger dual packer instead of a detailed probe. Moreover, in the rough modelling, the pressure variation far from the wellbore (e.g., at least a threshold distance from the wellbore) can be smaller than a threshold (e.g., nearly constant or linear) and therefore, in this case, a coarse mesh can yield accurate pressure prediction in the rough model 214. Regarding 2D modelling with n number of components (e.g., 4 components), using point source assumption, the fluid flow system can be asymmetric. In this case, the 3D modelling can be simplified into 2D cases on the vertical and radial plane which can further reduce the meshes and computational cost. Regarding 2D scalar pressure modelling, in some examples of rough modelling, the model can be reduced to only modelling the scalar pressure field. For example, the velocity vector can be eliminated by substituting Equation (2) into Equation (1), and the 2D pressure dynamical equation becomes:

$$μϕ \frac{\partial P}{\partial t} = {{k}_{v} ( \frac{\partial P}{\partial z} )}^{2} + {{k}_{h} ( \frac{\partial P}{\partial x} )}^{2} + \frac{1}{c} ( {k}_{v} \frac{{\partial }^{2} P}{\partial {z}^{2}} + {k}_{h} \frac{{\partial }^{2} P}{\partial {x}^{2}} ) \qquad Equation ( 8 )$$

wherein kₕ and kᵥ represent the horizontal and vertical permeabilities, respectively. In some examples, the normal fluid flow system has a number of state variable. For example, the normal fluid flow system can have four state variables. Moreover, the above pressure dynamic equation (e.g., Equation (8)) may have less state variables. For example, the above pressure dynamic equation may have one state variable. In some examples, the scalar pressure modelling can reduce the memory usage.

Regarding 1D isotropic pressure modelling, in the isotropic cases with kₕ=kᵥ=k, the pressure dynamic equation can be further simplified into a 1D equation as follows:

$$\frac{μϕ}{k} \frac{\partial P}{\partial t} = {( \frac{\partial P}{\partial r} )}^{2} + \frac{1}{c} \frac{{\partial }^{2} P}{\partial {r}^{2}} . \qquad Equation ( 9 )$$

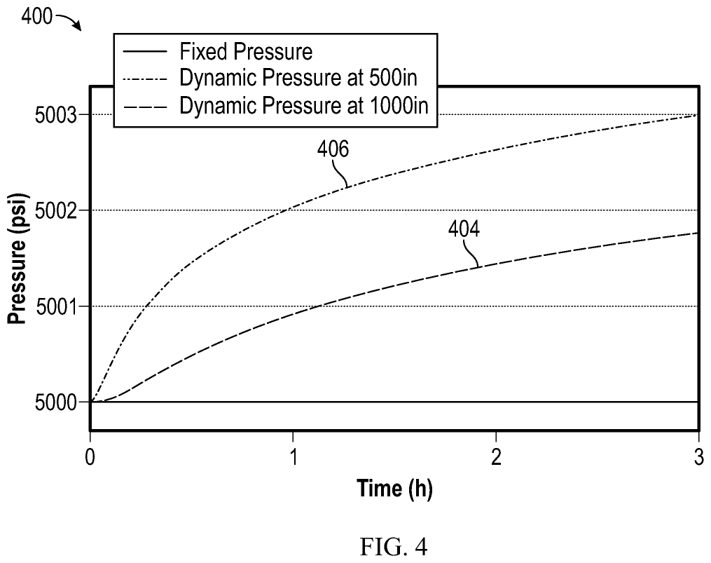

With the fixed boundary condition in Equation (6) on a larger model discussed above, any of the above rough modelling methods can be solved to obtain the general pressure field and monitor the pressure at the pre-designed rₘ as P_{d}(t) P(x=rₘ, z=0, t). Similar to the above injection example, the rough modelling can work on the model of a certain size, such as 4000 inches, and pressure monitored at a certain distance and/or radius, such as 500 inches. The rough model can be applied with the fixed far field to obtain the fluid flow model 216. For example, the rough model can be applied with a fixed far field pressure such as a fixed far field pressure of 5000 pound per square inch (psi). For example, FIG. 4 shows a graph 400 illustrating the dynamic pressures observed in the rough model 214. In this example, the dynamic pressure 406 was modeled at 500 in. In order to verify whether 500 in is a sufficient distance, dynamic pressure 404 was also monitored at 1000 in.

Returning to FIG. 2, the detailed model 224 will be explained in more detail. As illustrated in FIG. 2, the final result 230 can be provided by the detailed model 220, which considers the detailed features of wellbore and sampling probes (which can be ignored in the rough modelling described above). The detailed model 220 is designed with fine meshes on a smaller 3D model. In some examples, the detailed model 224 can be similar to normal fluid flow modelling. In some examples, the boundary condition can be reduced in the detailed model 224 by using the dynamic pressure instead of fixed far field pressure as the boundary condition on the outer surface of the detailed model 224 as follows:

$$P ( {r}_{M} , t ) = {P}_{d} ( t ) . \qquad Equation ( 10 )$$

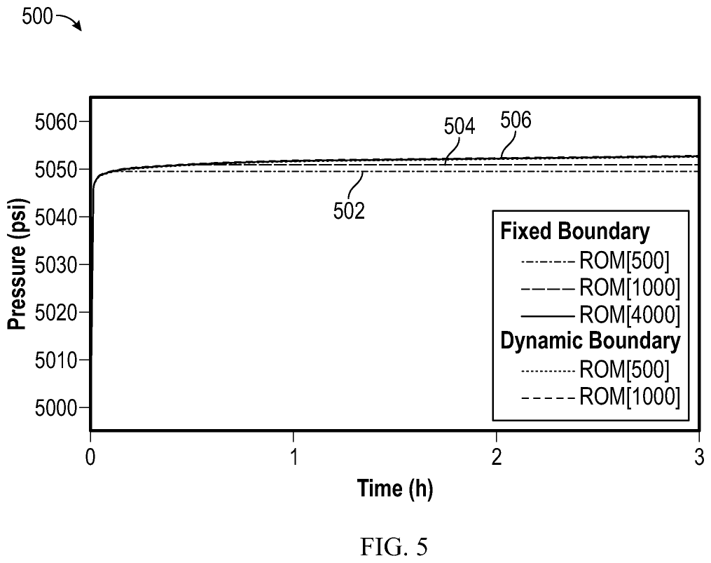

In the above example, the dynamic pressures can be used as the boundary conditions and provide the detailed fluid flow modelling 226 with certain radiuses, such as, for example, 500 in and 1000 in. Turning to FIG. 5, a graph 500 is shown that presents an example borehole pressure that supports a constant injection rate, such as a constant 50 cubic meter per second (cc/s) injection rate. For comparison, the fluid flow is also modeled with fixed far field pressure for model of one or more radii, such as radius 500 in (line 502), 1000 in (line 504) and 4000 in (line 506). In this example (e.g., rₚ=3375 in), the result of the model of a certain radius (e.g., the model having a radius of 4000 in) (e.g., line 506) can be seen as a reference. The modelling with fixed far field pressure (lines 502 and 504) are different from the reference due to the boundary effect. However, the multi-scale modelling with the dynamic pressure boundary condition can obtain the modelling results (line 506) that is essentially the same as that of the reference.

The multi-scale modelling systems and techniques described herein can be implemented by any numerical methods (or combination of numerical methods), including but not limited to FDM (finite difference methods or also known as FDFT method), FEM (finite elements method) and FVM (finite volume methods).

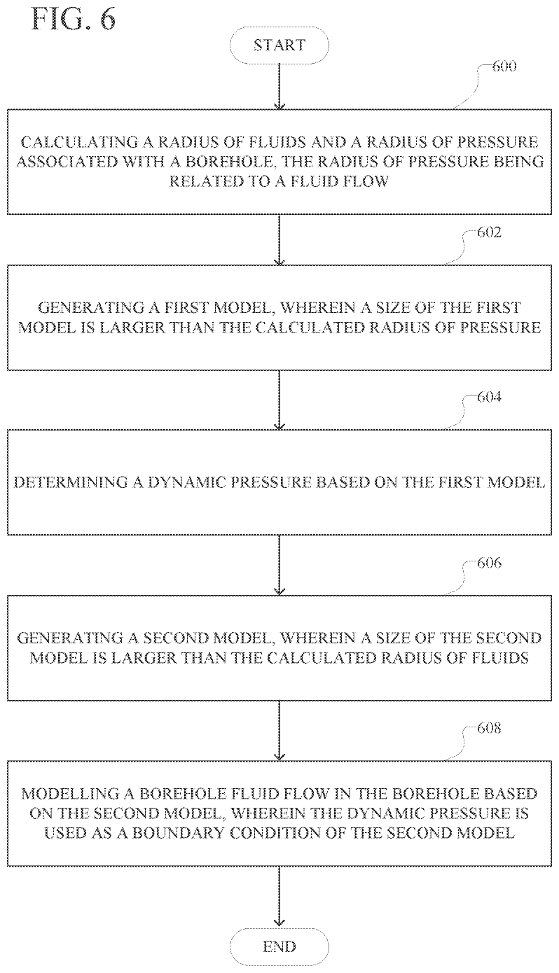

FIG. 6 is a flowchart illustrating an example process for modelling borehole fluid flow. At block 600, the process can include calculating a radius of fluids (e.g., radius of fluids (r_{f})) and a radius of pressure (radius of pressure (rₚ)) associated with a borehole, the radius of pressure (radius of pressure (rₚ)) being related to a fluid flow. In some examples, the radius of fluids (r_{f}) can be defined as the distance the fluid can reach after injection or sampling during time, with a flowrate q(t). In some examples, the radius of pressure (rₚ) can be defined as the distance that the pressure can propagate in the fluids. The distance of pressure propagation can depend on the mobility and compressibility of the fluids. Assuming that the reservoir rock has a porosity φ, the radius of fluids (r_{f}) can be described as follows:

$${r}_{f} = \sqrt[3]{\frac{3 V}{4 φπ}} . \qquad Equation ( 11 )$$

In some examples, the radius of pressure (rₚ) can be estimated as follows:

$${r}_{p} = 2 \sqrt{\frac{kt}{μφ c}} , \qquad Equation ( 12 )$$

wherein k can be the permeability on the fast direction, and μ and c are the viscosity and compressibility of the fluids, respectively.

At block 602, the process can include generating a first model (e.g., a rough model) wherein the size of the first model (e.g., a rough model) is larger than the calculated radius of pressure (radius of pressure (rₚ)). In some examples, the rough model 210 can have a large model size rar to reduce or avoid the boundary effect. As discussed above, the rough model 210 ignores the detailed features of probe to reduce the memory usage and computational time. In some examples, the rough model 214 can use a fixed far-field pressure on the outer surface. In these examples, the numerical model can be large enough so that (1) the fluids can never reach the outer boundary of the model during the whole fluid flow process, and (2) the pressure can never propagate to the outer boundary of the model. In order to obtain the accurate pressure field, the rough model 214 can be designed with the size r_{M}>rₚ to avoid the boundary effect.

At block 604, the process can include determining a dynamic pressure based on the first model (e.g., a rough model). In some examples, by employing a dynamic pressure boundary instead of fixed far-field pressure boundary during borehole fluid flow modelling, the proposed borehole fluid flow model can be smaller than the region of the pressure propagation, while also maintaining a high-resolution mesh to handle the detailed features of the probe and wellbore. In some examples, boundary effects can also be avoided by applying a dynamical pressure instead of the fixed far-field pressure on the outer surface boundary of a detailed model. The dynamic pressure boundary can be calculated from a rough model.

At block 606, the process can include generating a second model (e.g., detailed model) wherein the size of the second model (e.g., detailed model) is larger than the calculated radius of fluids (e.g., radius of fluids (r_{f})). As shown in FIG. 3, the rough model size (r_{M}) 302 can be larger than the radius of pressure (rₚ), while the detailed model size (rₘ) 306 can be larger than the radius of fluids (r_{f}) 308. In some examples, the detailed model 220 uses the dynamic pressure profile on the boundary of a smaller model with rₘ<<r_{M}.

At block 608, the process can include modelling a borehole fluid flow in the borehole based on the second model (e.g., detailed model), wherein the dynamic pressure is used as a boundary condition of the second model (e.g., detailed model). As discussed above, the rough model 210 ignores the detailed features of probe to reduce the memory usage and computational time, while the detailed model 220 uses a fine meshing to model the detailed features and control the meshing error. The method described can reduce both the boundary effect and the meshing error to produce a final result 230.

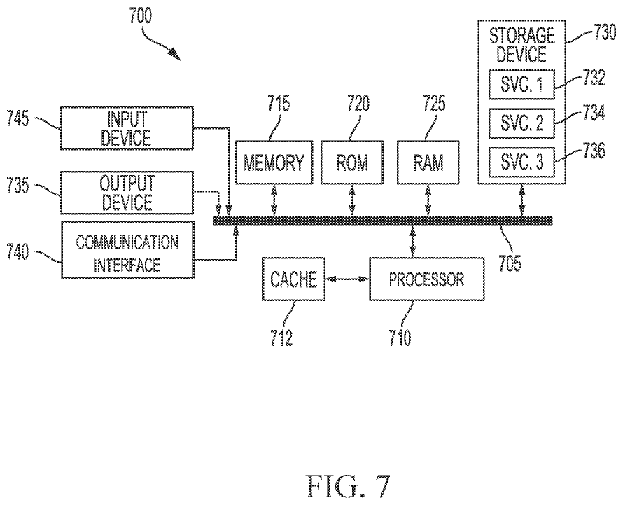

FIG. 7 illustrates an example computing device architecture 700 which can be employed to perform various steps, methods, and techniques disclosed herein. Specifically, the computing device architecture can be used to implement the method of borehole fluid flow modelling described herein.

As noted above, FIG. 7 illustrates an example computing device architecture 700 of a computing device which can implement the various technologies and techniques described herein. The components of the computing device architecture 700 are shown in electrical communication with each other using a connection 705, such as a bus. The example computing device architecture 700 includes a processing unit (CPU or processor) 710 and a computing device connection 705 that couples various computing device components including the computing device memory 715, such as read only memory (ROM) 720 and random access memory (RAM) 725, to the processor 710.

The computing device architecture 700 can include a cache of high-speed memory connected directly with, in close proximity to, or integrated as part of the processor 710. The computing device architecture 700 can copy data from the memory 715 and/or the storage device 730 to the cache 712 for quick access by the processor 710. In this way, the cache can provide a performance boost that avoids processor 710 delays while waiting for data. These and other modules can control or be configured to control the processor 710 to perform various actions. Other computing device memory 715 may be available for use as well. The memory 715 can include multiple different types of memory with different performance characteristics. The processor 710 can include any general purpose processor and a hardware or software service, such as service 1 732, service 2 734, and service 3 736 stored in storage device 730, configured to control the processor 710 as well as a special-purpose processor where software instructions are incorporated into the processor design. The processor 710 may be a self-contained system, containing multiple cores or processors, a bus, memory controller, cache, etc. A multi-core processor may be symmetric or asymmetric.

To enable user interaction with the computing device architecture 700, an input device 745 can represent any number of input mechanisms, such as a microphone for speech, a touch-sensitive screen for gesture or graphical input, keyboard, mouse, motion input, speech and so forth. An output device 735 can also be one or more of a number of output mechanisms known to those of skill in the art, such as a display, projector, television, speaker device, etc. In some instances, multimodal computing devices can enable a user to provide multiple types of input to communicate with the computing device architecture 700. The communications interface 740 can generally govern and manage the user input and computing device output. There is no restriction on operating on any particular hardware arrangement and therefore the basic features here may easily be substituted for improved hardware or firmware arrangements as they are developed.

Storage device 730 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 725, read only memory (ROM) 720, and hybrids thereof. The storage device 730 can include services 732, 734, 736 for controlling the processor 710. Other hardware or software modules are contemplated. The storage device 730 can be connected to the computing device connection 705. In one aspect, a hardware module that performs a particular function can include the software component stored in a computer-readable medium in connection with the necessary hardware components, such as the processor 710, connection 705, output device 735, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Moreover, claim language reciting “at least one of” a set indicates that one member of the set or multiple members of the set satisfy the claim. For example, claim language reciting “at least one of A and B” means A, B, or A and B.

Example Statements of the disclosure include:

Statement 1. A method comprising: calculating a radius of fluids and a radius of pressure associated with a borehole, the radius of pressure being related to a fluid flow; generating a first model, wherein a size of the first model is larger than the calculated radius of pressure; determining a dynamic pressure based on the first model; generating a second model, wherein a size of the second model is larger than the calculated radius of fluids; and modelling a borehole fluid flow in the borehole based on the second model, wherein the dynamic pressure is used as a boundary condition of the second model.

Statement 2. The method of statement 1, wherein the borehole fluid flow is modelled using at least one of a finite elements method, a finite difference method, and a finite volume method.

Statement 3. The method of any of statements 1 and 2, wherein the size of the second model is smaller than the size of the first model.

Statement 4. The method of any of statements 1 through 3, wherein the second model uses a fine meshing to model the borehole fluid flow.

Statement 5. The method of any of statements 1 through 4, wherein the first model uses a fixed far-field pressure on an outer surface of the first model.

Statement 6. The method of any of statements 1 through 5, wherein the size of the first model is large enough to avoid a boundary effect.

Statement 7. The method of any of statements 1 through 6, wherein the first model comprises a three-dimensional (3D) model with one or more meshes that are larger than a threshold size.

Statement 8. A system comprising: at least one memory; and at least one processor coupled to the at least one memory, the at least one processor configured to: calculate a radius of fluids and a radius of pressure associated with a borehole, the radius of pressure being related to a fluid flow; generate a first model, wherein a size of the first model is larger than the calculated radius of pressure; determine a dynamic pressure based on the first model; generate a second model, wherein a size of the second model is larger than the calculated radius of fluids; and model a borehole fluid flow in the borehole based on the second model, wherein the dynamic pressure is used as a boundary condition of the second model.

Statement 9. The system of statement 8, wherein the borehole fluid flow is modelled using at least one of a finite elements method, a finite difference method, and a finite volume method.

Statement 10. The system of any of statements 8 and 9, wherein the size of the second model is smaller than the size of the first model.

Statement 11. The system of any of statements 8 through 10, wherein the second model uses a fine meshing to model the borehole fluid flow.

Statement 12. The system of any of statements 8 through 11, wherein the first model uses a fixed far-field pressure on an outer surface of the first model.

Statement 13. The system of any of statements 8 through 12, wherein the size of the first model is large enough to avoid a boundary effect.

Statement 14. The system of any of statements 8 through 13, wherein the first model comprises a three-dimensional (3D) model with one or more meshes that are larger than a threshold size.

Statement 15. A non-transitory computer-readable storage medium comprising at least one instruction for causing a computer or processor to: calculate a radius of fluids and a radius of pressure associated with a borehole, the radius of pressure being related to a fluid flow; generate a first model, wherein a size of the first model is larger than the calculated radius of pressure; determine a dynamic pressure based on the first model; generate a second model, wherein a size of the second model is larger than the calculated radius of fluids; and model a borehole fluid flow in the borehole based on the second model, wherein the dynamic pressure is used as a boundary condition of the second model.

Statement 16. The non-transitory computer-readable storage medium of statement 15, wherein the borehole fluid flow is modelled using at least one of a finite elements method, a finite difference method, and a finite volume method.

Statement 17. The non-transitory computer-readable storage medium of any of statements 15 and 16, wherein the size of the second model is smaller than the size of the first model.

Statement 18. The non-transitory computer-readable storage medium of any of statements 15 through 17, wherein the second model uses a fine meshing to model the borehole fluid flow.

Statement 19. The non-transitory computer-readable storage medium of any of statements 15 through 18, wherein the first model uses a fixed far-field pressure on an outer surface of the first model.

Statement 20. The non-transitory computer-readable storage medium of any of statements 15 through 19, wherein the size of the first model is large enough to avoid a boundary effect.

What is claimed is:

1. A method comprising:
calculating a radius of fluids and a radius of pressure associated with a borehole, the radius of pressure being related to a fluid flow;
generating a first model, wherein a size of the first model is larger than the calculated radius of pressure;
determining a dynamic pressure based on the first model;
generating a second model, wherein a size of the second model is larger than the calculated radius of fluids; and
modelling a borehole fluid flow in the borehole based on the second model, wherein the dynamic pressure is used as a boundary condition of the second model.

2. The method of claim 1, wherein the borehole fluid flow is modelled using at least one of a finite elements method, a finite difference method, and a finite volume method.

3. The method of claim 1, wherein the size of the second model is smaller than the size of the first model.

4. The method of claim 1, wherein the second model uses a fine meshing to model the borehole fluid flow.

5. The method of claim 1, wherein the first model uses a fixed far-field pressure on an outer surface of the first model.

6. The method of claim 1, wherein the size of the first model is large enough to avoid a boundary effect.

7. The method of claim 1, wherein the first model comprises a three-dimensional (3D) model with one or more meshes that are larger than a threshold size.

8. A system comprising:
at least one memory; and
at least one processor coupled to the at least one memory, the at least one processor configured to:
calculate a radius of fluids and a radius of pressure associated with a borehole, the radius of pressure being related to a fluid flow;
generate a first model, wherein a size of the first model is larger than the calculated radius of pressure;
determine a dynamic pressure based on the first model;
generate a second model, wherein a size of the second model is larger than the calculated radius of fluids; and
model a borehole fluid flow in the borehole based on the second model, wherein the dynamic pressure is used as a boundary condition of the second model.

9. The system of claim 8, wherein the borehole fluid flow is modelled using at least one of a finite elements method, a finite difference method, and a finite volume method.

10. The system of claim 8, wherein the size of the second model is smaller than the size of the first model.

11. The system of claim 8, wherein the second model uses a fine meshing to model the borehole fluid flow.

12. The system of claim 8, wherein the first model uses a fixed far-field pressure on an outer surface of the first model.

13. The system of claim 8, wherein the size of the first model is large enough to avoid a boundary effect.

14. The system of claim 8, wherein the first model comprises a three-dimensional (3D) model with one or more meshes that are larger than a threshold size.

15. A non-transitory computer-readable storage medium comprising at least one instruction for causing a computer or processor to:
calculate a radius of fluids and a radius of pressure associated with a borehole, the radius of pressure being related to a fluid flow;
generate a first model, wherein a size of the first model is larger than the calculated radius of pressure;
determine a dynamic pressure based on the first model;
generate a second model, wherein a size of the second model is larger than the calculated radius of fluids; and
model a borehole fluid flow in the borehole based on the second model, wherein the dynamic pressure is used as a boundary condition of the second model.

16. The non-transitory computer-readable storage medium of claim 15, wherein the borehole fluid flow is modelled using at least one of a finite elements method, a finite difference method, and a finite volume method.

17. The non-transitory computer-readable storage medium of claim 15, wherein the size of the second model is smaller than the size of the first model.

18. The non-transitory computer-readable storage medium of claim 15, wherein the second model uses a fine meshing to model the borehole fluid flow.

19. The non-transitory computer-readable storage medium of claim 15, wherein the first model uses a fixed far-field pressure on an outer surface of the first model.

20. The non-transitory computer-readable storage medium of claim 15, wherein the size of the first model is large enough to avoid a boundary effect.
